(19) United States
(12) Patent Application Publication
(10) Pub. No.: US 2011/0106717 A1
(43) Pub. Date: May 5, 2011

(54) QUALITY CONTROL RECORD AND DATA PROCESSING SYSTEM FOR CREATING AND MAINTAINING SAME

(75) Inventors: Ronald Konopacki, Suffield, CT (US); Robert Crocker, East Granby, CT (US); Carl Neuschaefer, Enfield, CT (US)

(73) Assignee: ALSTOM TECHNOLOGY LTD., Baden (CH)

(21) Appl. No.: 12/898,988

(22) Filed: Oct. 6, 2010

Related U.S. Application Data
(60) Provisional application No. 61/257,662, filed on Nov. 3, 2009.

(51) Int. Cl. G06Q 99/00; G06F 17/00; G06F 17/30

(52) U.S. Cl. 705/317; 707/600; 707/E17.001

(57) ABSTRACT

A system and method are presented for creating and maintaining quality control records. The system includes a plurality of client devices. Each client device captures information, data and decisions associated with raw material, components and assemblies of components. The information, data and decisions document operations and operating conditions at a plurality of stages in a life cycle of the raw materials, components and assemblies. The system includes a communication network and one or more servers operatively coupled to the client devices over the network. The servers create quality control records including the information, data and decisions for the materials, components and assemblies. The system includes one or more data stores that store the quality control records. The information, data and decisions includes measurements and readings taken by the input-output devices and decisions made at the stages and that document properties of the raw materials, components and assemblies.

### CROSS REFERENCE TO RELATED APPLICATIONS

This patent application claims benefit under 35 U.S.C. §119(e) of copending, U.S. Provisional Patent Application Ser. No. 61/257,662, filed Nov. 3, 2009. This patent application also relates to U.S. patent application Ser. No. ______, filed concurrently herewith (attorney docket no. WO9/069-1). The disclosures of these U.S. patent documents are incorporated by reference herein in their entireties.

### BACKGROUND

1. Technical Field

The disclosed subject matter relates to a system and process for collecting, organizing and storing information, data and decisions associated with raw materials, components and/or assemblies of components within quality control records. More particularly, the disclosed subject matter relates to a system and process for creating, maintaining and utilizing quality control records to document operations and operational conditions at various stages of design, purchasing, manufacture, assembly, shipping, installation and operation, including various steps of process, test and/or inspection of the raw materials, components and/or assemblies.

2. Description of Related Art

Generally speaking, raw materials, components and assemblies of components undergo a variety of stages from an initial concept and design stage, to a receipt of raw materials and/or purchased components stage, to a manufacture and assembly stage, to a shipment of finished components and/or assemblies of components stage, and to an installation and operation in the field stage. These stages typically include periodic reviews and other inspection and/or certification operations where one or more measurements and/or readings are taken to ensure that the raw materials, components and/or assemblies conform to requisite standards. Often, the measurements and readings are used for “go”/“no go” decision making to continue the progression through the stages or to be directed off-line for re-work, scrap or the like. Once made, the measurements, readings and determinations based thereon are typically discarded. That is, unless expressly required by customer or internal compliance based procedures, the measurements, readings and determinations based thereon are not saved for any meaningful period of time.

The inventors have recognized that it is beneficial to collect, organize, store and retrieve information, data and decisions throughout the variety of stages in a life cycle of a component or assembly of components, e.g., the concept and design stage, the receipt stage, the manufacture and assembly stage, the shipment, and the operation stage. Accordingly, an improved quality control system and process is presented that includes steps of collecting, organizing, storing and retrieving information, data and decisions associated with raw materials, components and/or assemblies of components. The system and process creating, maintaining and utilizing quality control records, including the information, data and decisions, and documenting operations and operating conditions at various stages of design, manufacture, assembly, shipment and use, including process, test and/or inspection steps and data generated therein and decisions based thereon.

### SUMMARY

According to aspects illustrated herein, there is provided a system and method for creating and maintaining quality control records for raw materials, components and/or assemblies of components. The method includes collecting information, data and decisions associated with at least one of a raw material, a component and an assembly of components. The information, data and decisions documents at least one of operations and operating conditions at a plurality of stages in a life cycle of the at least one raw material, component and assembly. The method also includes assigning a unique identifier to the raw material, component and assembly; and creating a quality control record. The quality control record includes the unique identifier, the information and the data. The method also includes storing the quality control record; and accessing the quality control record to at least maintain and/or view the quality control record and the information and the data included therein.

In one embodiment, the information, data and decisions includes measurements and readings taken at one or more of the plurality of stages. The measurements and readings document properties of the at least one raw material, component and assembly. The properties include physical properties, compositional properties and resistance properties of the raw material, component and assembly documented at one or more of the life cycle stages.

According to another aspect illustrated herein, the system includes a plurality of client devices. Each client device has a processor and input-output devices that cooperate to capture information, data and decisions associated with at least one of a raw material, a component and an assembly of components. The information, data and decisions documents at least one of operations and operating conditions at a plurality of stages in a life cycle of the at least one raw material, component and assembly. The system also includes a communication network and a server having a processor. The server is operatively coupled to the client devices over the communication network. The server creates at least one quality control record including the captured information, data and decisions for the at least one raw material, component and assembly. The system also includes a data store operatively coupled to the server. The data store receives and stores the quality control records.

In one embodiment, the input-out devices include optical and bar code scanners and readers, keyboard, mouse and other pointing device, a monitor and a printer. The input-output devices capture, document, store and display the information, data and decisions associated with the at least one raw material, components and assemblies of components. In one embodiment, the captured information, data and decisions includes measurements and readings taken by the input-output devices at one or more of the plurality of stages. The measurements and readings document properties of the at least one raw material, component and assembly. The properties include physical properties, compositional properties and resistance properties of the at least one raw material, component and assembly. In yet another embodiment, the captured information, data and decisions includes processes and procedures performed at one or more of the stages, including test and inspection steps, and decisions based thereon.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 illustrates a data processing system for creating and maintaining quality control records documenting information, data and decisions associated with raw materials, components and assemblies of components, according to one embodiment disclosed herein.

FIG. 2 depicts stages in a life cycle of the raw materials, components and assemblies, according to one embodiment disclosed herein.

### DETAILED DESCRIPTION

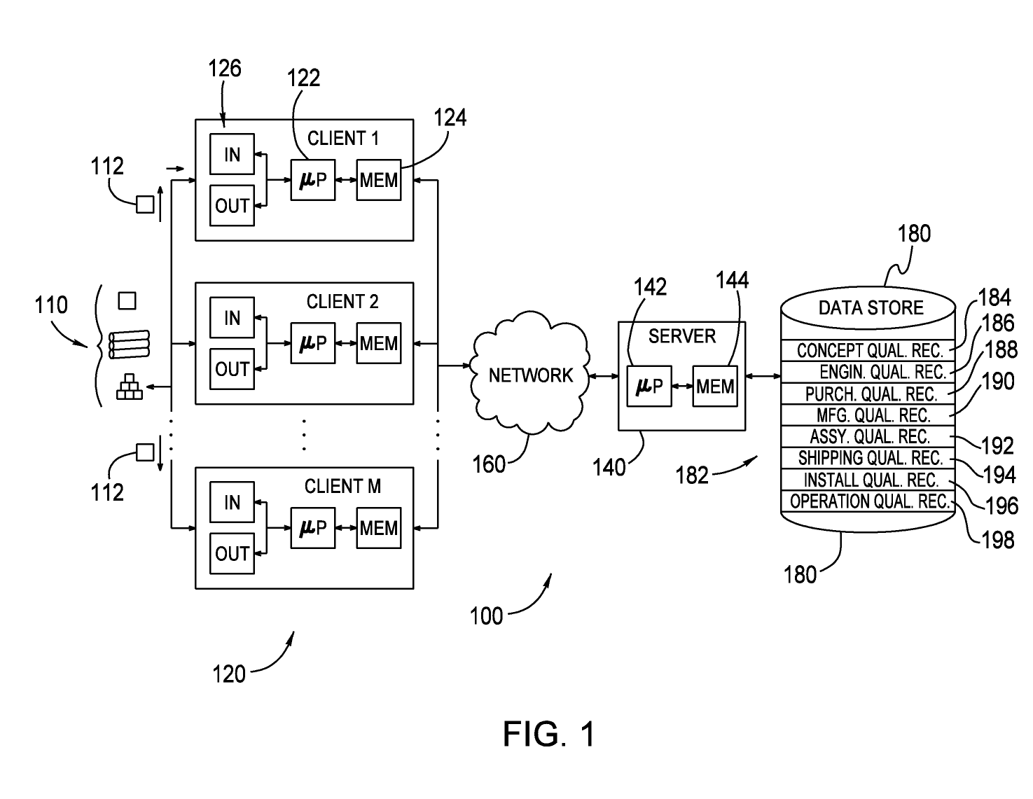

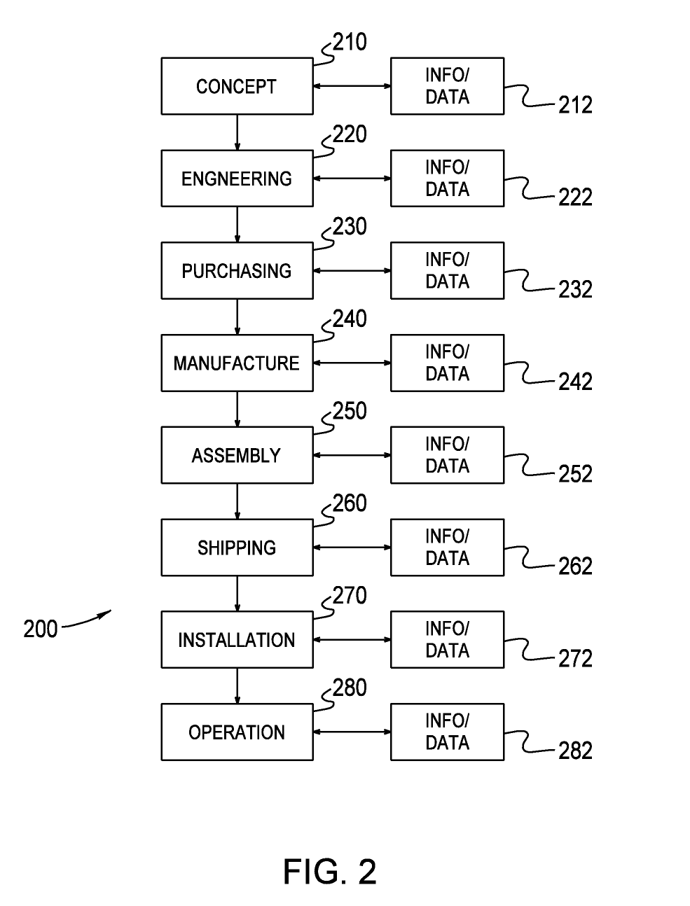

FIGS. 1 and 2 illustrate a data processing system 100 configured and operating, in accordance with one embodiment, to implement techniques for creating and maintaining quality control records. The quality control records capture and document information, data and decisions associated with raw materials, components and/or assemblies of components 110, and document operations and operating conditions at various stages within a life cycle 200 of the raw materials, components and/or assemblies including, for example, design, purchasing, manufacture, assembly, shipping, installation and operation stages, and process, test and/or inspection steps related thereto. As can be appreciated, within one or more of the life cycle stages 200 information, data and decisions 112 including, for example, measurements and readings of properties of the raw materials, components and assemblies 110, are generated and decisions based thereon, are made. As described herein, in one embodiment, the information, data and decisions 112 are captured in real-time as processes and procedures within the life cycle stages 200 are performed, and stored in the quality control records. The records are created, maintained and made available by the data processing system 100 to authorized persons accessing the system 100. Accordingly, the records provide a component and/or assembly profile. The profile documents a history of physical, compositional, and resistance properties, as well as other information, data and decisions, of the raw materials, components and assemblies 110 during one or more of the respective life cycle stages 200 and process steps within the stages 200.

As shown in FIG. 1, the data processing system 100 includes a plurality of client devices (e.g., Client 1-M), shown generally at 120, operatively coupled to one or more servers (one server shown for simplification) 140 over a communication network 160 such as, for example, the Internet, an intranet, an extranet, or like distributed communication platform connecting computing devices over wired and/or wireless connections. In one embodiment, the client devices 120 and server 140 may each include a processor 122 and 142, computer-readable medium or memory 124 and 144, and input-output devices 126 including devices for capturing or receiving input (e.g., the information, data and decisions 112), and presenting the information, data and decisions 112 to authorized users, and for facilitating communication by the client devices 120 and server 140 over the network 160. The processors 122 and 142 execute program instructions stored in the memory 124 and 144 such that authorized users operating individual ones of the client devices 120 may communicate over the network 160 with other client devices 120 as well as other computing devices coupled to the network, such as the server 140. It should be appreciated that the client devices 120 may comprise include, for example, a standalone or networked personal computer (PC), workstation, laptop, tablet computer, personal digital assistant, pocket PC, Internet-enabled mobile radiotelephone, pager or like computing devices. One or more of the client devices 120 and the server 140 are located in a single facility, or are located remotely in one or more facilities anywhere in the world, and communicate over the network 160. While not shown, it should be appreciated that one or more of the client devices 120 and the server 160 include security features for inhibiting unauthorized access to the data processing system 100. In one embodiment, the input-output devices 126 may include optical and bar code scanners and readers, keyboard and mouse or other pointing device, monitor, printer and the like, that are used to capture, store and display the information, data and decisions 112 associated with the raw materials, components and/or assemblies of components 110.

The server 140 is operatively coupled to a data store 180. It should be appreciated that the data store 180 may be a relational data base, object oriented data base or other suitable data repository, as is known in the art. In one embodiment, the data store 180 stores one or more quality control records, shown generally at 182, that document the information, data and decisions 112 associated with raw materials, components and/or assemblies of components 110 and that document operations and operating conditions at various stages within the life cycle 200 of the raw materials, components and/or assemblies. It should be appreciated that the server 140 may include two or more servers 140 operatively coupled to two or more data stores 180. The two or more servers 140 and two or more data stores 180 cooperating to store, maintain and display/distribute the quality control records 182 at and between a plurality of facilities (e.g., an engineering facility, a manufacturing facility, a production facility and the like) within the system 100. In one embodiment, the quality control records 182 include an aggregate of information, data and decisions collected, stored and/or maintained at the plurality of facilities for each of the raw materials, components and/or assemblies. For example, one quality control record 182 may include information, data and decisions from one or more of the stages of the life cycle of the raw materials, components and/or assemblies and the measurements, readings and/or decision taken and made therein. In one embodiment, one of the servers 140 and the data stores 160 may include local information, data and decisions that, until approved, is not provided for display/distribution within the system 100 to other servers 140 and/or data stores 160. In one embodiment, a selected one of the servers 140 and/or the data stores 160 is a master server and/or master data store that is a central or control point for display/distribution of the collected information, data and decisions (e.g., the quality control records 182) throughout the system 100.

As noted above and illustrated graphically in FIG. 2, the stages of the life cycle 200 of components and assemblies 110 include, for example, concept 210, engineering 220, purchasing 230, manufacture 240, assembly 250, shipping 260, installation 270 and operation 280 stages, with process, test and/or inspection steps included therein. As discussed below, within one or more of the stages, the information, data and decisions 112 including, for example, measurements and readings of physical, compositional, and resistance properties of the raw materials, components and assemblies 110, are generated and decisions based thereon, are made. As described herein, the information, data and decisions 112 are stored in the data store in one or more quality control records 182 created, maintained and made available to authorized persons by the data processing system 100. The information, data and decisions 112 are collected, organized, stored and retrieved within one or more quality control records 182 to provide long term visibility and tracking capability not seen in the art.

As shown in FIG. 2, the life cycle 200 begins with the concept stage 210. At the concept stage 210, component and/or assembly need assessment may be conducted to determine desired properties and/or operational characteristics and functions of the component and assembly 110. One or more concepts for the components and/or assemblies may be outlined and reviewed, before a decision to proceed with planning and design of the components and/or assemblies is made. As conceptual information, data and decision 212 of the information, data and decisions 112 and related to the need assessment and/or conceptual design is created, it is stored in the data store 180 as one of the quality control records 182, for example, a concept quality control record 184. In one embodiment, the concept quality control record 184 may include one or more, general to specific conceptual designs, need assessment information, desired properties and/or operational characteristics and functions of proposed components and/or assemblies, manufacturing requirements, installation scenarios, procedures, and the like.

Once a conceptual design is approved, the design is typically passed to the engineering stage 220. At the engineering stage 220, the conceptual information, data and decisions 212 may be reviewed and discussed, and detail design and requirements planning is performed. In the engineering stage, engineering design information, data and decisions 222 of the information, data and decisions 112 for the components and/or assemblies 110 is created. The engineering design information, data and decisions 222 may include, for example, material and/or chemical composition (e.g., elements and percentages within a material or alloy), physical properties of dimensions (e.g., inside diameter and outside diameter, roundness, wall thickness), and/or structural or resistance properties such as hardness, tensile strength and the like, of components and assemblies 110. The engineering design information, data and decisions 222 may also include component and assembly drawings and bills of material for assemblies, and approvals of the same. In one embodiment, the raw materials, components and assemblies 110 are assigned a unique identification 114 and the information, data and decisions 112 associated therewith are coded with the unique identification 114 for easier and more reliable association. In one embodiment, the raw materials, components and assemblies 110 are marked, stamped, printed, tagged or otherwise identified physically with the unique identification 114. In one embodiment, the identification is a machine and/or human readable bar code, dot peen or other marking of a numeric and/or alpha numeric code.

Additionally, the engineering design information, data and decisions 222 may include technical and quality inspection and/or review procedures, decisions, approvals and the like. As the engineering design information, data and decisions 222 is created, it is stored in the data store 180 as one of the quality control records 182, for example, an engineering quality control record 186. With the engineering design information, data and decisions 222 created, decisions are often made with respect to purchasing and/or manufacturing the necessary raw materials, components and assemblies, as well as production, assembly and delivery costs and schedules, and the like. These decisions may also be included in the quality control records 182, for example, in the engineering quality control record 186.

At the purchasing stage 230, the engineering information, data and decisions 222 is reviewed by, for example, retrieving and viewing the engineering quality control record 186 associated with the identification 114 for the subject component and/or assembly 110. The purchasing stage 230 includes documenting material certifications for purchased and/or manufactured raw materials, components and/or assemblies, checking vendor qualification and availability, determining pricing, and creating and defining instructions outlining delivery, inspections and/or verification procedures, and other requirements. As purchasing information, data and decisions 232 of the information 112 and related to the aforementioned certifications, qualifications and availability, pricing, delivery, inspection and verification and other requirements are created, it is stored in the data store 180 as one of the quality control records 182, for example, a purchasing quality control record 188. At the manufacturing stage 240, the engineering information, data and decisions 222 is reviewed by, for example, retrieving and viewing the engineering quality control record 186, and requirements, procedures, production schedules are created, and/or availability determined for manufacture of components and/or assemblies at current or planned resources. As manufacturing information, data and decisions 242 of the information 112 and related to the aforementioned requirements, procedures, production schedules, and availability of resources, are created, it is stored in the data store 180 as one of the quality control records 182, for example, a manufacturing quality control record 190. In one embodiment, the manufacturing information, data and decisions 242 may include, for example, information and requirements for inspection such as material and/or chemical composition, physical properties and dimensions (e.g., inside diameter, outside diameter), roundness, wall thickness, weight and/or structural or resistance properties of hardness, tensile strength and the like, of the components and assemblies. The manufacturing information, data and decisions 242 may also include, for example, component and/or assembly preparation and manufacturing procedures such as requisite end preparations, cuts, bend and swages requirements, weld, and heat treatment requirements and the like, as well as operator and inspector identification, time and date stamps, batch or run identification, quantities and the like.

At the assembly stage 250, components and assemblies that are either purchased and/or manufactured may be joined, coupled or otherwise combined to form larger assemblies. At the assembly stage 250 one or more of the engineering information, data and decisions 222, the purchasing information, data and decisions 232, and the manufacturing information, data and decisions 242, is reviewed by, for example, retrieving and viewing one or more of the respective quality control records 186, 188 and 190 associated with the identification 114 for the subject component and/or assembly 110. Based thereon and/or on other consideration, procedures and instructions for assembly, and supporting inspections and/or verification procedures are defined. As assembly information, data and decisions 252 of the information 112 and related to the aforementioned procedures, instructions, inspections, verification and other steps or requirements are created, it is stored in the data store 180 as one of the quality control records 182, for example, an assembly quality control record 192.

At the shipping stage 260, the assemblies or, in some instances, components, are packaged for transport and/or delivery to another manufacturing or assembly facility, customer location or the like. As with prior stages, one or more of the engineering information, data and decisions 222, the purchasing information, data and decisions 232, the manufacturing information, data and decisions 242, and assembly information, data and decisions 252 is reviewed by, for example, retrieving and viewing one or more of the respective quality control records 186, 188, 190 and 192 associated with the identification 114 for the subject component and/or assembly 110. Based thereon and/or on other consideration, procedures and instructions for packaging and shipping, and supporting inspections and/or verification procedures, are defined. As shipping information, data and decisions 262 of the information 112 and related to the aforementioned procedures, instructions, inspections, verification and other steps or requirements are created, it is stored in the data store 180 as one of the quality control records 182, for example, a shipping quality control record 194.

At the installation stage 270, the shipped components and assemblies are unpacked, assembled or installed in a predetermined configuration (e.g., location or orientation on site) for operation within a field of interest. At the installation stage 270 one or more of the engineering information, data and decisions 222, the purchasing information, data and decisions 232, the manufacturing information, data and decisions 242, the assembly information, data and decisions 252, and the shipping information, data and decisions 262 may be reviewed by, for example, retrieving and viewing one or more of the respective quality control records 186, 188, 190, 192 and 194 associated with the identification 114 for the subject component and/or assembly 110. Based thereon and/or on other consideration, procedures and instructions for installation, and supporting inspections and/or verification procedures are defined to ensure that an installed configuration conforms to the predefined operational configuration. As installation information, data and decisions 272 of the information 112 and related to the aforementioned procedures, instructions, inspections, verification and other steps or requirements are created, it is stored in the data store 180 as one of the quality control records 182, for example, an installation quality control record 196.

At the operation stage 280, the installed components and/or assemblies are continuously or periodically monitored to detect proper and/or improper operation of the components and/or assemblies or, one or more operating conditions. At the operation stage 280 one or more of the engineering information, data and decisions 222, the purchasing information, data and decisions 232, the manufacturing information, data and decisions 242, the assembly information, data and decisions 252, the shipping information, data and decisions 262, and installation information, data and decisions 272 may be reviewed by, for example, retrieving and viewing one or more of the respective quality control records 186, 188, 190, 192, 194 and 196 associated with the identification 114 for the subject component and/or assembly 110. Based thereon and/or on other considerations, operational procedures, steps or instructions including, for example, exemplary performance data, inspections and/or verification procedures, and periodic maintenance and/or repair are defined and performed. As operational information, data and decisions 282 of the information 112 and related to the aforementioned procedures, instructions, inspections, maintenance and repair steps or requirements are created, it is stored in the data store 180 as one of the quality control records 182, for example, an operational quality control record 198.

As described herein, it should be appreciated that the information, data and decisions 112, 212, 222, 232, 242, 252, 262, 272, and 282 at one or more of the aforementioned concept 210, engineering 220, purchasing 230, manufacture 240, assembly 250, shipment 260, installation 270 and operation 280 stages is collected in real-time as operations and procedures are being performed. Accordingly, creation, maintenance, and utilization of the quality control records 182 is not overly burdensome on personnel and does not significantly impact the cost of performing the aforementioned procedures. As such, the benefit of accessing and reviewing the quality records 182 documenting properties throughout the life cycle 200 of the raw materials, components and assemblies 110 is significant and not diminished by overly burdensome activities and/or associated costs.

It should be appreciated that while described above as creating quality control records 182 at one or more steps within the stages of the life cycle 200 of raw material, component and assemblies of components 110, it is within the scope of the present invention to maintain one quality control record for each raw material, component and assemblies and to update the one quality control record during the one or more stages to include additional information, data and decisions 112. In one embodiment, the one quality control record may be indexed or accessed by the unique identification 114. Moreover, it is also within the scope of the present invention to aggregate the information, data and decisions 112 to provide statistical data regarding, for example, performance at one or more stages in the life cycle 200 for all raw material, component and assemblies of components 110 undergoing operations at one or more of the life cycle stages, and/or for each individual or a select subset of raw material, component and assemblies of components 110 undergoing operations at one or more stages in the life cycle.

Unless otherwise specified, all ranges disclosed herein are inclusive and combinable at the end points and all intermediate points therein. The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item. All numerals modified by “about” are inclusive of the precise numeric value unless otherwise specified.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for creating and maintaining a quality control record, the method comprising:
collecting, by input devices, information, data and decisions associated with at least one of a raw material, a component and an assembly of components, the information, data and decisions documenting at least one of operations and operating conditions at a plurality of stages in a life cycle of the at least one raw material, component and assembly;
assigning, by a first processor, a unique identifier to the at least one raw material, component and assembly;
creating, by the first processor, a quality control record, the quality control record including the unique identifier, the information, data and decisions;
storing, in a data store coupled to the first processor, the quality control record; and
accessing the data store from one of a plurality of client devices, the accessing including at least one of maintaining, by second processors of the client devices, and viewing, by output devices of the client devices, the quality control record of the at least one raw material, component and assembly, and the information, data and decisions included therein.

2. A method according to claim 1, wherein the information, data and decisions includes measurements and readings taken by the input devices and decisions based thereon made at one or more of the plurality of stages, the measurements and readings recording properties of the at least one raw material, component and assembly.

3. A method according to claim 2, wherein the properties of the at least one raw material, component and assembly include physical properties, compositional properties and resistance properties.

4. A method according to claim 3, wherein the physical properties of the at least one raw material, component and assembly include at least one of dimensions such as an inside diameter, an outside diameter and wall thickness, weight, roundness and concentricity.

5. A method according to claim 3, wherein the compositional properties of the at least one raw material, component and assembly include at least one of material and chemical composition including elements and percentages within a material or alloy.

6. A method according to claim 3, wherein the resistance properties of the at least one raw material, component and assembly include hardness and tensile strength.

7. A method according to claim 1, wherein the information, data and decisions include conceptual designs, need assessments, desired properties, operational characteristics and functions of the at least one raw material, component and assembly.

8. A method according to claim 1, wherein the information, data and decisions include drawings and bills of material, technical and quality inspection and review procedures, decisions, and approvals thereof for the at least one raw material, component and assembly.

9. A method according to claim 1, wherein the information, data and decisions include material certification for purchased and manufactured raw materials, components and assemblies, vendor qualification and availability, pricing, delivery instructions, inspections and verification procedures thereof.

10. A method of claim 1, wherein the information, data and decisions include component and assembly preparation and manufacturing procedures including end preparations, cuts, bend and swages requirements, weld, and heat treatment requirements, operator identification, inspector identification, time stamp, a date stamp, a batch or run identification, and quantity manufactured per batch or run.

11. A method according to claim 1, wherein the plurality of stages in the life cycle of the at least one raw material, component and assembly include one or more of concept, engineering, purchasing, manufacture, assembly, shipping, installation and operation stages.

12. A method according to claim 1, wherein the first processor is included within a server and the plurality of client devices are located in one of a same facility as the server and one or more of a plurality of remotely located facilities from the server, the server and client devices operatively coupled over a communication network.

13. A method according to claim 1, wherein the input devices include optical and bar code scanners and readers, keyboard, mouse and other pointing device, and the output devices include a monitor and a printer, the input devices and the output devices cooperating to capture, record, store, display and distribute the information, data and decisions associated with the at least one raw material, components and assemblies of components.

14. A processing system for creating and maintaining quality control records, the processing system comprising:
a plurality of client devices, each having a processor and input-output devices that cooperate to capture information, data and decisions associated with at least one of a raw material, a component and an assembly of components, the information, data and decisions document at least one of operations and operating conditions at a plurality of stages in a life cycle of the at least one raw material, component and assembly;
a communication network;
one or more servers each having a processor, the one or more servers operatively coupled to the plurality of client devices over the communication network, the one or more servers create at least one quality control record including the captured information, data and decisions for the at least one raw material, component and assembly; and
one or more data stores operatively coupled to the one or more servers, the one or more data stores receive and store the at least one quality control record.

15. A system according to claim 14, wherein the input-output devices include optical and bar code scanners and readers, keyboard, mouse and other pointing device, a monitor and a printer, the input-output devices capture, document, store, display and distribute the information, data and decisions associated with the at least one raw material, components and assemblies of components.

16. A system according to claim 14, wherein the captured information, data and decisions includes measurements and readings taken by the input-output devices and decisions based thereon made at one or more of the plurality of stages, the measurements and readings documenting properties of the at least one raw material, component and assembly.

17. A system according to claim 16, wherein the properties of the at least one raw material, component and assembly include physical properties, compositional properties and resistance properties.

18. A system according to claim 14, wherein the captured information, data and decisions include processes and procedures performed at one or more of the plurality of stages including process, test and inspection steps and decisions based thereon.

19. A system according to claim 14, wherein the one or more servers and the plurality of client devices are located in at least one of a same facility and one or more of a plurality of remotely located facilities.

20. A system according to claim 14, wherein the at least one quality control record includes an aggregate of the captured information, data and decisions associated with the at least one of raw material, component and assembly at the plurality of stages in the life cycle of the at least one raw material, component and assembly.
